(19) United States
(12) Patent Application Publication
(10) Pub. No.: US 2006/0096614 A1
(43) Pub. Date: May 11, 2006

(54) Surface treating methods, compositions and articles

(76) Inventor: Annette J. Krisko, Sauk City, WI (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/269,159

(22) Filed: Nov. 8, 2005

Related U.S. Application Data
(60) Provisional application No. 60/626,051, filed on Nov. 8, 2004.

(51) Int. Cl. B08B 7/00; B05D 3/00

(52) U.S. Cl. 134/6; 427/140

(57) ABSTRACT

Compositions, articles, and methods for treating substrate surfaces to impart functional properties to the surface or to restore functional properties to functional coatings borne on such surfaces. Compositions may be provided as abrasive particles dispersed in a liquid medium, a solution or a gel. Articles for treating substrate surfaces, such as a glass surfaces, include fabrics impregnated with such composition and kits comprised of the composition and a fabric which may be impregnated with such compositions. In a method of treating, a substrate having a surface is provided. The surface of the substrate may include a functional coating. The surface is treated by washing, wiping or other application of the composition to the substrate surface or functional coating borne on the surface.

### CROSS-REFERENCE TO RELATED APPLICATION

This application claims priority to U.S. Provisional Application No. 60/626,051, filed Nov. 8, 2004, which is incorporated herein by reference.

### FIELD OF THE INVENTION

The present invention relates to compositions, articles and methods for treating substrate surfaces. More particularly, the invention relates to abrasive compositions, articles and methods for treating glass substrate surfaces bearing a functional coating and for forming a functional coating on such surfaces.

### BACKGROUND OF THE INVENTION

Surfaces of glass sheets and other substrates are often coated with functional coatings to impart desired properties to the substrate. The coatings applied to the glass sheets vary widely and may include low-emissivity coatings, photocatalytic coatings, anti-reflective coatings, transparent conductive coatings, hydrophobic coatings, or hydrophilic coatings. Further, a coating may be applied simply to impart a specific color to the glass sheet. Such coatings are generally referred to herein as functional coatings.

A low emissivity coating may be applied to a glass sheet and also acts to reduce the passage of infrared radiation through the glass. This reduces loss or gain of heat through glass, thereby enhancing the ability to control the temperature in the building. Low-emissivity coatings are well known in the art and typically include one or more layers of infrared-reflective metal and one or more transparent dielectric layers. The infrared-reflective layers, which are typically conductive metals such as silver, gold, or copper, reduce the transmission of radiant heat through the coating. The transparent dielectric layers are used primarily to reduce visible reflectance and to control other properties of the coatings, such as color. Commonly used transparent dielectrics include oxides of zinc, tin, indium, bismuth, and titanium, and alloys and mixtures thereof, as well as certain nitrides (e.g., silicon nitride and titanium nitride). Low-emissivity coatings are commonly deposited on glass substrates through the use of well known magnetron sputtering techniques. Functional coatings such as hydrophilic, hydrophobic or photocatalytic coatings may be further applied to glass sheets separately or as part of or over low-emissivity coatings and known sputtering techniques may also be used, as well as others known to those skilled in the art.

Photocatalytic coatings may be applied to provide self-cleaning characteristics to glass or other substrates. A photocatalytic coating applied to the outer surfaces of a glass sheet window reduces the time and cost associated with cleaning the outer surface of the window. The field of photocatalytic coating technology is founded on the ability of certain materials to absorb radiation and photocatalytically degrade organic materials such as oil, plant matter, fats, and greases. The most powerful of these photocatalytic materials appears to be titanium oxide. However, other materials are believed to exhibit photoactivity as well. These materials include oxides of iron, silver, copper, tungsten, aluminum, zinc, strontium, palladium, gold, platinum, nickel, and cobalt. Useful photocatalytic coatings are described in U.S. Pat. No. 5,874,701 (Watanabe et al), U.S. Pat. No. 5,853,866 (Watanabe et al), U.S. Pat. No. 5,961,843 (Hayakawa et al.), U.S. Pat. No. 6,139,803 (Watanabe et al), U.S. Pat. No. 6,191,062 (Hayakawa et al.), U.S. Pat. No. 5,939,194 (Hashimoto et al.), U.S. Pat. No. 6,013,372 (Hayakawa et al.), U.S. Pat. No. 6,090,489 (Hayakawa et al.), U.S. Pat. No. 6,210,779 (Watanabe et al), U.S. Pat. No. 6,165,256 (Hayakawa et al.), and U.S. Pat. No. 5,616,532 (Heller et al.), the entire contents of each of which are incorporated herein by reference.

Hydrophobic coatings are applied to glass to repel water, thus causing the water to bead up, rather than spreading into a sheet. U.S. Pat. No. 5,424,130 to Nakanishi, et al., the teachings of which are incorporated herein by reference, suggests coating a glass surface with a silica-based coating which incorporates fluoroalkyl groups. The reference teaches applying a silicone alkoxide paint onto the surface of the glass, drying the paint and then burning the dried paint in air.

Hydrophobic (i.e., “water repellent”) coatings tend to cause water on the surface of the glass to bead up. These beads or water droplets may dry and cause water stains on glass surfaces, whether in architectural, automobile or other uses. In automobile windshields or the like, this beading effect can help remove water from the glass surface. When the automobile is operated at sufficient speed a constant flow of high velocity air is blown over the surface causing water beads or droplets to blow off the surface. However, in more quiescent applications, these droplets will tend to sit on the surface of the glass and slowly evaporate. Thus, a glass surface bearing a hydrophobic functional coating will nonetheless require periodic cleaning.

Hydrophilic coatings have an affinity for water and tend to cause water applied thereto to sheet. The use of such coatings avoid the beading and water stains associated with hydrophobic coatings. As described in U.S. patent application Ser. Nos. 09/868,542, 09/868,543, 09/599,301, and 09/572,766, the entire contents of each of which are incorporated herein by reference, hydrophilic coatings may be particularly advantageous when used on architectural glass and other substrates. For example, these coatings may resist formation of stains left by sitting water droplets, thereby promoting a longer lasting clean appearance and reducing the frequency between cleanings.

Antireflective coatings may also be applied to the surface of a glass sheet. For example, U.S. Pat. No. 5,394,269 to Takamatsu, et al., the entire teachings of which are incorporated herein by reference, proposes a “minutely rough” silica layer on the surface of glass to reduce reflection. The roughened surface is achieved by treating the surface with a supersaturated silica solution in hydrosilicofluoric acid to apply a porous layer of silica on the glass sheet.

Functional properties are sometimes deteriorated or diminished when the functional coating is exposed to contamination, debris, indoor or outdoor environmental conditions and the like. Thus, functional coating can become fouled or contaminated resulting in loss or reduction in their performance or functional properties.

Coated surfaces of glass sheets can become contaminated when the glass is exposed to manufacturing, shipping, handling, window fabrication and installation. For example, while in glass manufacturing environments, coated surfaces are often exposed to organics and other residues that can build up on and contaminate these surfaces. For example, various solvents, curing products, and sealants used in manufacturing glass products produce residues that may contaminate coated surfaces. The atmosphere in the manufacturing facility may also contain vapors capable of contaminating coated surfaces. For example, silicone is commonly used as a sealant in the manufacture of insulating glass units (IG units). Newly deposited silicone may outgas for significant periods of time and coated surfaces exposed to this outgassing may accumulate silicone residue.

Contamination can be particularly problematic for substrate surfaces bearing coatings having functional properties, for example, specific surface properties. For example, substrates bearing hydrophilic coatings often have specific water-sheeting surface properties, which are often compromised when contaminated. Hydrophilic coatings have an affinity for water and tend to cause water applied thereto to sheet. These coatings are believed to resist formation of water stains, thereby promoting a longer lasting clean appearance. When these coatings are contaminated with silicones and other residues, the desired hydrophilic surface becomes undesirably hydrophobic. It has been surprisingly difficult to protect glass surfaces bearing hydrophilic surfaces from contamination by materials like silicone.

Coated surfaces can also become deteriorated over time, especially when the surface is exposed to an outdoor environment. While exposed to an outdoor environment, coated surfaces are often exposed to fog, rain, dirt, UV radiation and other outdoor conditions, which often cause functional properties of the surfaces to become deteriorated. For example, in the case of hydrophilic coatings, excessive exposure to ultraviolet radiation often deteriorates hydrophilic properties of hydrophilic coatings. Also, excessive exposure to fog, rain and other outdoor environmental conditions often deteriorate hydrophilic properties of hydrophilic coatings. Thus, it is desirable to provide a method for treating surfaces bearing contaminated or deteriorated coatings to remove the contaminants and restore the functional properties of the coatings. For example, it is desirable to provide a method for treating surfaces bearing contaminated or deteriorated hydrophilic coatings to remove contaminants and properties and restore the hydrophilic properties of the coating.

Abrasives and other cleaning solutions are known for cleaning substrate surfaces to remove contaminants. For example, cerium oxide scrubs have been applied to uncoated glass surfaces for polishing, grinding and finishing glass surfaces. Soft Scrub™ cleansers, manufactured by Clorox Company, have also been used for cleaning uncoated glass surfaces. These scrubs have been effective in removing contaminants mechanically bound to surfaces. However, these scrubs are not intended to be used on coated glass surfaces. Those skilled in the art recognize that abrasives are generally not used on coated surfaces to avoid the surface being scratched or otherwise damaged by the abrasive. Abrasives are also not intended to be used to remove contaminants, for example silicone, chemically bound to a coating. Rather, chemical washes have been used to remove chemically bound coatings. Thus, while abrasive materials have been in use for cleaning and polishing uncoated substrates surfaces, such materials have not been used for washing or otherwise treating a substrate surface bearing a coating. Prior abrasive scrubs are also generally not intended to be left on the glass surfaces after cleaning and often require several rinses to completely remove. Thus, it is also desirable to provide a method for treating surfaces bearing coatings that is easy to apply and does not require excessive rinsing.

### SUMMARY OF INVENTION

The present invention in various embodiments provides compositions, articles and methods for treatment of substrates to impart functional properties to their surfaces or to restore functional properties to functional coatings borne on their surfaces.

In various embodiments of compositions according to the inventions, a composition comprising abrasive particles dispersed in a liquid media, solutions or gels is provided. The particles may be formed of the same or different materials as the surface to be treated. Examples of useful abrasive particles include but are not limited to crystalline silica, aluminum silica, titanium oxide (e.g., titanium sesquioxide, titanium dioxide, titanium trioxide), zinc oxide, aluminum oxide, topaz, silicon carbide, and boron nitride. Additional non-limiting examples of useful materials include materials known to be utilized to form photocatalytic coatings, e.g., photoactive oxide and non-oxide semiconductor, transition metal oxides, carbides, sulfides and other functional coating. Compositions may be comprised of mixtures of two or more different types of abrasive particles.

Articles such as fabrics impregnated with compositions according to the invention are provided. “Fabric” as referred to herein should be understood to include fabric material, a cloth, paper towel, sponge, kimwipe, towelette, or similar article without limitation. Additionally, kits comprised of the composition and a fabric as are also provided. In embodiments of kits according to the invention, the fabric may be provided without being impregnated with a composition or may be so impregnated and package along with the composition in a suitable container from which the composition may be dispensed.

In various embodiments of methods according to the invention a substrate is provided and treated with the composition.

In an embodiment of a method according to the invention a method of restoring functional properties to a glass surface bearing a functional coating is provided comprising: providing a glass surface bearing a functional coating; and treating the functional coating borne on the glass surface with abrasive particles dispersed in a solution or a gel until the functional properties of the functional coating are restored.

In another embodiment, a method of restoring functional properties to a surface bearing a functional coating is provided comprising: providing a surface bearing a functional coating and treating the functional coating borne on the surface with abrasive particles dispersed in a solution or a gel until the functional properties are restored.

In another embodiment, a method of imparting at least one functional property to a glass substrate is provided comprising: providing a glass substrate, the glass substrate having at least one surface exposed to the environment and treating the exposed surface with abrasive particles dispersed in a solution or a gel until a coating of the abrasive particles is formed on the surface, the abrasive particles having at least one functional property.

In yet another embodiment, a method of imparting hydrophilic functional properties to a glass substrate having an exposed surface is provided comprising: providing a glass substrate having an exposed surface, the exposed surface having a hardness on the Mohs scale, providing abrasive particles dispersed in a solution or gel, the abrasive particles being silica particles having a hardness on the Mohs scale that is not greater than the hardness of the exposed surface and having a particle size of between about 1 micron to about 500 microns; and treating the exposed surface with the abrasive particles until a coating of the abrasive particles is formed on the surface, the coating having hydrophilic properties.

In a further embodiment a method of restoring functional properties to a surface bearing a functional coating is provided comprising: providing a surface bearing a functional coating, the functional coating having a hardness on the Mohs scale, providing abrasive particles dispersed in a solution or gel, the abrasive particles having a hardness on the Mohs scale and having a particle size of between about 1 micron to about 500 microns, the difference between the hardness of the coating and the particles being not greater than 2 on the Mohs scale; and treating the functional coating borne on the surface with the abrasive particles until the functional properties of the coating are restored.

In yet a further embodiment, a method of restoring hydrophilic properties to a surface bearing a silicon dioxide coating having hydrophilic properties is provided comprising: providing the surface bearing a silicon dioxide coating having hydrophilic properties; and treating the silicon dioxide coating with silica abrasive particles dispersed in a solution or a gel until the hydrophilic properties of the coating are restored.

In various embodiments of the composition, articles and methods of the invention the the abrasive particles and the coating to which the particles are intended to be applied each have a hardness on the Mohs scale. The abrasive particles may be selected to so that the difference between the hardness of the coating and the particles is not greater than 2 on the Mohs scale. They may also be selected so that the hardness of the abrasive particles is not greater than the hardness of the functional coating. Also, in various embodiments, the particles may be of various sizes; however, particles having an average particle size ranging from about 1 micron to about 500 microns are particularly useful in some embodiments or applications.

### BRIEF DESCRIPTION OF THE DRAWINGS

FIG. 1 is a block diagram of an embodiment of a method of the invention.

FIG. 2 is a block diagram of an embodiment of a method of the invention.

FIG. 3 is a block diagram of an embodiment of a method of the invention.

FIG. 4 is a block diagram of an embodiment of a method of the invention.

FIG. 5 is a block diagram of an embodiment of a method of the invention.

FIG. 6 is a block diagram of an embodiment of a method of the invention.

FIG. 7 illustrates a side view of a substrate having a surface bearing a coating that can be treated according to the invention;

FIG. 8 illustrates a perspective view of a substrate bearing a coating that can be treated according to the invention that is incorporated into an IG unit; and

FIG. 9 illustrates a perspective view of a substrate bearing a coating that can be treated according to the invention that is mounted in an outer wall of a building.

### DETAILED DESCRIPTION OF THE PREFERRED EMBODIMENTS

The following detailed description is to be read with reference to the drawings, in which like elements in different drawings have been given like reference numerals. The drawings, which are not necessarily to scale, depict selected embodiments and are not intended to limit the scope of the invention. Skilled artisans will recognize that the examples given have many useful alternatives that fall within the scope of the invention.

The invention generally provides compositions, articles and methods for treating a surface of a substrate, and more specifically of glass substrates. The term “treating” as used herein and in the claims hereof refers to and includes treatment of either uncoated surfaces or of surfaces bearing a functional coating. Treating may be for purposes of cleaning a surface (coated or uncoated), restoring functional properties of a functional coating borne on a surface, or imparting functional properties to a surface (coated or uncoated). Treating generally involves application of a composition according to the invention to a surface with a rubbing or frictional force applied either manually (for example, by hand with a fabric, cloth, towelette or similar article) or mechanically (for example, with an application devise such as a polishing drill, buffer or other apparatus equipped with an application element incorporating a fabric, cloth, fiber or other suitable application material) to clean, wipe, wash, rub or scrub a surface. The composition may be applied directly to the surface or first deposited on a fabric or other medium or on the element of an application device.

The surfaces to which compositions according the invention may be applied may appear to be smooth to the naked eye or to the touch. However, as observed under electromicroscopes or other similar devices, the surface, both coated and uncoated, may be seen to be irregular or textured, having features akin to peaks and valleys or other features. These features being at the microscopic level, the rubbing or frictional force applied during treating coupled with sizing of the abrasive particles allows for the composition to be worked into the surface and any structural features thereof, promoting contact with contaminants whether physically or chemically bound.

With treating or treatment according to the embodiments of the invention, contaminants whether physically or chemically bound or adhered to a surface (coated or uncoated) can be removed to clean the surface or to restore functional properties of a functional coating borne on a surface. Further, functional properties can be imparted to a surface (coated or uncoated) through the formation of a functional coating with a composition according to embodiments of the invention. The term “functional coating”, as used herein, should be understood by those skilled in the art to refer to any coating having specific surface properties. Examples of coatings having specific surface properties include but are not limited to hydrophilic coatings, hydrophobic coatings and photocatalytic coatings.

The term “hydrophilic” is used herein to refer to any coating, surface or material that tends to cause water applied thereto to form a sheet, rather than bead up.

The term “hydrophobic” is used herein to refer to any coating, surface or material that tends to cause water applied thereto to bead up rather than to form a sheet.

The term “photocatalytic” is used herein to refer to any coating, surface or material that absorbs ultraviolet radiation and photocatalytically degrades organic materials or compounds.

Compositions according to various embodiments of the invention are generally comprised of abrasive particles and more specifically are comprised of abrasive particles dispersed in a liquid medium, a solution or gel. The abrasive particles may be of the same or different materials as the surface being treated or the functional coating borne on the surface being treated. With respect to glass or other transparent surfaces, the abrasive particles are preferably formed of a material that will not visibly mar, scratch or destroy either the surface being treated (coated or uncoated); more preferably, the abrasive particles and compositions formed therefrom will form a transparent coating or otherwise will not leave any noticeable or visible residue. Particles and compositions that do not leave a visible residue are preferred for some applications; however, in other applications, residues that may be formed can be removed by rinsing or washing them off.

In compositions according to the invention, abrasive particles are dispersed or contained in a liquid medium, either as a solid dispersion in a solution or a gel. A variety of liquids are suitable for containing the abrasive particles. The liquid medium serves to disperse the abrasive particles in order to reduce the friction between the substrate, e.g., glass, the abrasive particles, and/or the cloth or fabric or application element. If dispersed in a gel, which is a semi-solid dispersion or colloidal suspension, friction will need to be reduced with use or application of a liquid such as water or the liquid modified to form the gel during treating. Further, a greater or increased application of a rubbing or frictional force will likely be required in order to distribute the composition over the treated surface and to work the composition.

Those skilled in the art will readily understand that liquids are preferably selected based upon their compatibility with the abrasive particles and/or the surface or functional coating being treated. This consideration applied to the liquid used in formation of compositions according to embodiments of the invention or to liquids used during treating with a gel. To be compatible the liquid is preferably one that interacts in a neutral manner, meaning for example, that the liquid is non-corrosive relative to abrasive particles, the surface or functional coating or does not chemically react with or otherwise erode the abrasive particles, the surface or the functional coating borne on the surface.

Suitable or useful liquids include, but are not limited to water, alcohol, mildly acidic solutions, mildly basic solutions, liquid glass cleaners, acetone and the like. Examples of mildly acidic solutions include aqueous solution containing acids such as acetic acid, citric acid, formic acid to name a few, or very dilute acids or vinegar. On the other hand, the solution may contain a mild base such as a soap or cleaning fluid. Many commercially available glass cleaners, e.g., Windex® brand glass cleaner, are mild bases. The solution may also be an alcoholic solution. For example, the solution may contain an alcohol such as isopropyl alcohol. The solution may also be an aqueous solution. For example, the solution may contain an acidic aqueous solution such as vinegar and water or citric acid and water or the solution may be an alcoholic aqueous solution such as isopropyl alcohol and water. The solution may also be comprised only of water.

In certain embodiments, the solution may comprise a mixture of water and vinegar. Any commercially available vinegar can be used. In other embodiments, the solution may comprise isopropyl alcohol and water. This solution may, for example, contain 50% isopropyl alcohol and 50% water; however, it should be understood that the two components may be present in different ratios besides 1:1. In yet other embodiments, the solution comprises a commercially available glass cleaner. One example of a commercial available glass cleaner is Windex® brand glass cleaner, manufactured by SC Johnson and Sons, Inc, located in Racine, Wis.

The methods, compositions, and articles of the invention, in their various embodiments, may be used to treat a variety of substrates, including but not limited to architectural and other glass substrates (e.g., mirrors, automobile windows, glass lenses, etc.) and substrates formed of synthetic or polymeric materials, composites, multi-layered substrates, such as those used in solar cells and the like. Of particular but not exclusive interest to Applicants is architectural glass such as is used in windows and spandrels. Therefore, it may be useful in understanding the various embodiments of the invention, to discuss architectural glass as well as coatings that may be formed thereon before discussing the types or materials that may be utilized as abrasive particles in compositions and methods of the invention.

Architectural glass products are exposed to the environment and often bear functional coatings, exhibiting hydrophilic, hydrophobic, photocatalytic or other desirable properties. Whether provided with or without functional coatings, the surface of these and other substrates may be come fouled or the functional coating borne thereon my be come fouled or their functional properties otherwise reduced, diminished or lost as a result of exposure. may be formed of various materials such as transparent dielectric films.

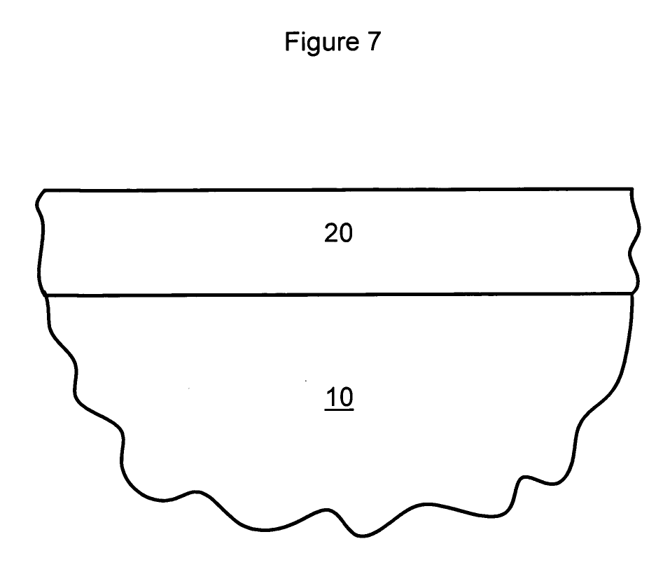

Generally, any substrate surface bearing a coating can be treated according to the invention. With respect to architectural glass, in most cases, the substrate is sheet like (e.g., having two generally-opposed major surfaces). A sheet-like substrate 10 bearing a coating 20 is illustrated in FIG. 7. Preferably, the sheet-like substrate is a sheet of glass. A variety of known glass types can be used, and soda lime glass is one typically preferred example. The sheet of glass may be a window pane mounted in a window. The window pane can be a single pane or part of a multi-pane insulating glass unit. Also for architectural purposes the sheet of glass may be a spandrel or a monolithic sheet of glass.

Referring to FIG. 7, for purposes of discussion, the substrate 10 is a window pane mounted in a window. Again, the pane can be a single pane mounted in a window or part of a multi-pane insulating glass unit that is mounted in a window. The surface of the substrate bears a coating 20 which may be a functional coating. When coating 20 is on an exterior surface of a window or window unit, it is exposed to either an indoor or an outdoor environment and may come into contact with dirt, water, contaminants, and the like. If coating 20 is a functional coating, this contact may result in the coating becoming fouled.

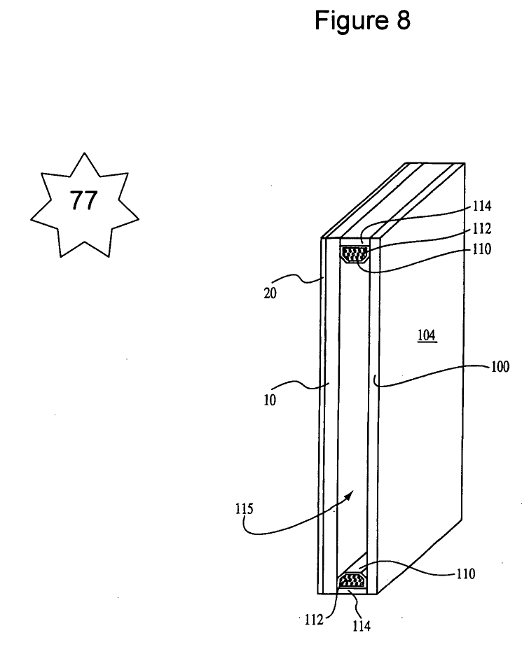

FIG. 8 illustrates the substrate 10 as incorporated into a multi-pane insulating glass unit 30. The IG unit 30 comprises two panes of glass 10, 100 held in a spaced-apart relationship by a spacer 110. The spacer is typically formed of a hollow tube of metal or plastic. The spacer 110 can optionally be provided with a desiccant 112 that is allowed to communicate with the gas in the between-pane space. This desiccant communicates with the gas in the interpane space 115 to remove any moisture which may seep between the panes of glass 10, 100. An exterior seal 114 may be carried around the external periphery of the spacer 110 to form a reliable gas and moisture barrier. Such desiccant is useful in removing moisture that may permeate between the panes. An edge seal can be applied around the periphery of the spacer 110 to form a gas and moisture barrier. The edge seal commonly comprises silicone which, as noted above, can outgas for extended periods of time. IG unit 30 is illustrated with only pane 10 bearing a coating; however, in other commercially available IG units, pane 100, may also be provided with a coating on its exterior surface. The present composition and methods can be used to treat the coated exterior surface of pane 10 or an uncoated surface of pane 100.

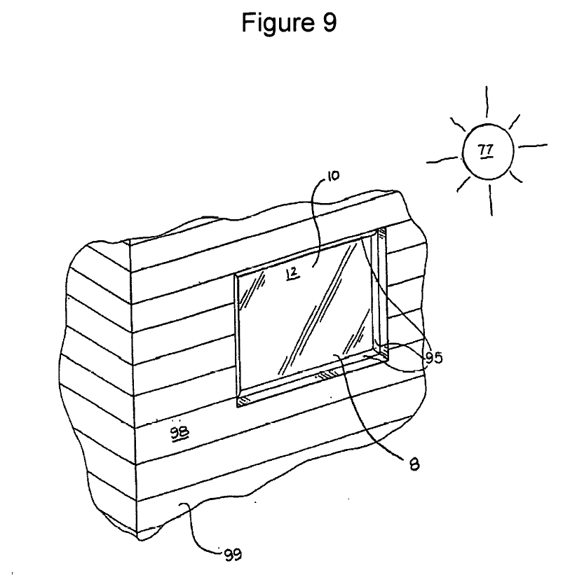

FIG. 9 illustrates the substrate 10 functioning as a window pane in a window. The substrate 10 is mounted within a frame 95 in an exterior wall 98 of a building 99. The substrate 10 can be a single sheet-like substrate as shown in FIG. 7 mounted within the frame 95 or it can be part of multi-pane insulating glass unit as shown in FIG. 8 mounted within the frame 95. Either way, the substrate 10 is illustrated with an exterior surface bearing a coating and exposed to sunlight 77 and other outdoor environmental conditions.

The coating 20 deposited on the surface of the substrate 10 can be any coating known in the art deposited by any known coating deposition method, such as a vacuum coating method. Well known vacuum coating methods include sputtering, evaporation, and other forms of physical and chemical vapor deposition (e.g., plasma-assisted C.V.D.) or plasma-enhanced chemical vapor deposition (“PECVD”) and are utilized to provide coatings, often with functional properties. Reference is made to U.S. Pat. Nos. 3,814,983 and 5,062,508, containing disclosure relating to deposition methods, the entire teachings of each of which are incorporated herein by reference.

In architectural and other glass, functional coatings may be formed of various materials such as transparent dielectric films. The term “transparent dielectric” is used herein to refer to any non metallic (i.e., neither a pure metal nor a pure metal alloy) compound that includes any one or more metals and is substantially transparent when deposited as a thin film by techniques known to those skilled in the art of glass manufacture. Included within this definition are any metal oxide, metal carbide, metal nitride, metal sulfide, metal boride, and any combination thereof, e.g., a metal oxynitride. Further, the term “metal” as used herein refers to all metals and semi-metals (i.e., metalloids). Examples of oxides known to be useful for thin films include oxides of zinc, tin, indium, bismuth, titanium, aluminum, hafnium, zirconium and mixtures thereof, to name a few. While metal oxides are desirable due to their ease of deposition and low cost application, know metal nitrides (e.g., silicon nitride and titanium nitride) can also be used. Skilled artisans will be familiar with other useful materials for formation of thin films or functional coatings.

Hydrophilic coatings and surfaces typically have a contact angle with water of less than about 25 degrees. Substrates bearing hydrophilic coatings are disclosed in Applicant's own U.S. Pat. No. 6,660,365 and U.S. patent application Ser. Nos. 09/868,542 and 09/572,766, the entire contents of each of which are incorporated herein by reference. Examples of hydrophilic materials or coatings include but are not limited to silicon dioxide (SiO₂). Though any of the foregoing may be used to form abrasive particles, silicon dioxide is a particularly preferred hydrophilic coating as is described in detail in U.S. Pat. No. 6,660,365 and U.S. patent application Ser. No. 09/868,542, the entire teachings of each of which are incorporated herein by reference. Thus, silicon dioxide is particularly useful as hydrophilic abrasive particles in compositions and methods according to the invention. Carbon based water-sheeting materials and coatings formed therefrom are described in detail in U.S. patent application Ser. No. 09/572,766, the entire teachings of which are herein incorporated by reference. Such carbon based materials may also be utilized as abrasive particles in the compositions and coatings of the invention.

Various material are known to be utilized to form photocatalytic coatings, e.g., photoactive oxide and non-oxide semiconductor, transition metal oxides, carbides, sulfides and other functional coatings. They included oxides of iron, silver, copper, tungsten, aluminum, zinc, strontium, palladium, gold, platinum, nickel, and cobalt and other photoactive transition metal oxides, e.g., anatase form of titanium oxide, rutile form of titanium oxide, zinc oxide, tin oxide, ferric oxide, dibismuth trioxide, tungsten trioxide, and strontium titanate. Additional examples of photocatalytic materials include, but are not limited to: SnO₂, CaTiO₃, MoO₃, NbO₅, Tiₓ Zr₍₁₋ₓ₎O₂, SiC, SrTiO₃, CdS, CdSe, FeTiO₃, GaP, GaAs, GeAs, RuO₂, MOS₃, LaRhO₃, CdFeO₃, Bi₂O₃, MOS₂, In₂O₃, CdO, InP, and the like. Titanium oxide is one of the more powerful photocatalytic materials and therefore is a preferred photocatalytic material.

Thus, the abrasive particles used in the various embodiments of the invention may be formed of the aforementioned materials and may additionally be formed of fine particles formed of such materials as ceramics, topaz and the like. Silicon dioxide is another useful material.

Abrasive particles used in compositions of the invention may also be formed of the same or different materials as the surface to be treated. For some applications, the particles may preferably be formed of the same material as the functional coating. For other applications, the particles may preferably be formed of a material different from that of the functional coating or, in the case of an uncoated surface, of a material different from the material from which the substrate is formed.

As earlier noted, the abrasive particles are preferably formed of a material that will not visibly mar, scratch or destroy the surface being treated (coated or uncoated). Applicants have discovered that such marring, scratching or destruction can be avoided by with attention to the respective hardness of the particles and the surface or coating being treated. Functional coatings and abrasive particles have a hardness that can be measured on the Mohs or other scale, such as a Modified Mohs scale or the Knoop scale, classifying minerals based on relative hardness in order from softest to hardest. The hardness of a mineral is gauged by its ability to scratch or be scratch by one of ten standard minerals in the Mohs scale. The 10 standard minerals are listed in increasing order of hardness corresponding to hardness of 1-10 respectively: Talc (1), Gypsym (2), Calcite (3), Flourite (4), Apatite (5), Orthoclase or Feldspar (6), Quartz SiO2 (7), Topaz (8), Corundum or Sapphire (9), and Diamond (10). Each mineral is scratchable by all having a higher number. Although hardness is generally discussed herein using the standard Mohs scale, those skilled in the art will readily understand that Mohs hardness may be converted to another hardness scale and that hardness may be expressed and/or compared using a different hardness scale and still be within the scope of the invention.

Typically, the hardness of the abrasive particles, uncoated surfaces and of functional coating borne on surfaces will range between about 3 to about 8 on the Mohs scales. To avoid visible marring of a surface or coating, abrasive particles may have a hardness equal to the hardness of the surface or coating being treated. The hardness does not have to be the same or equal; however, the difference between the hardness of the abrasive particles and of the surface or functional coating preferably is not greater than about 2 on the Mohs scale. For some embodiments of the methods of the invention, the abrasive particles may preferably have a hardness that is not greater than the hardness of the surface or the functional coating being treated.

In addition to hardness, particle size may influence the effectiveness or desired form of treatment. Particles of various sizes may be utilized in the composition, articles and methods of the invention. Applicant has found that the particles having an average particle size ranging from about 1 micron to about 500 microns to be beneficial in some embodiments and applications.

The inventors have discovered that treating a substrate surface bearing a coating with an abrasive composition imparts unexpected beneficial properties onto that coating. Often times, a chemical treatment is needed to remove chemically bound contaminants. However, it is unexpected that a mechanical treatment with abrasive particles would remove chemically bound contaminants, especially without scratching the surface. Applicants have applied abrasive compositions of the invention and observed the remove of chemically bound contaminants from a coated surface without scratching or otherwise damaging that surface. Applicants have also observed also unexpectedly improvements in the surface tension of a coated surface and the imparting or restoration of hydrophilic properties. Several surfaces may benefit from an improvement in surface tension. For example, the composition can be used to improve the surface tension of a hydrophilic coating, which helps to restore hydrophilic properties to that coating. A functional hydrophilic coating has a low contact angle with water, which causes water to sheet. When a hydrophilic surface is contaminated, the contact angle with water is increased, which causes water to bead up rather than sheet. A contaminated hydrophilic coating can be treated with the abrasive composition to improve the surface tension of the coating so that a lower contact angle is again present, thereby improving the hydrophilic properties of the coating Additionally, an uncoated surface, such as a glass surface may be treated to form a coating having hydrophilic properties. Or, an abrasive composition of the invention can also be used to improve the surface tension of any other coating, thereby imparting hydrophilic properties into a non-hydrophilic coating. They may similarly be used to restore or impart photocatalytic properties to a surface. Thus, the abrasive compositions and methods of the invention can be used to restore or improve functional properties of a coating.

The composition generally comprises abrasive particles dispersed in a liquid medium or gel solution. Examples of useful abrasive particles include but are not limited to crystalline silica, aluminum silica, titanium oxide (e.g., titanium sesquioxide, titanium dioxide, titanium trioxide), zinc oxide, aluminum oxide, topaz, silicon carbide, boron nitride, or mixtures of two or more above. In certain embodiments, the abrasive particles include silica particles. Preferably, the silica particles are silica gel. Silica gel is generally a porous, granular form of silica, typically synthetically manufactured from sodium silicate. Silica gel is well known in the art and available from several commercial resources.

In compositions according to the invention abrasive particles may be dispersed in solution or gels as earlier discussed above. The amount of abrasive particles per milliliter of solution, solvent or liquid medium can be varied with the present composition. Preferably, the composition includes between about 0.5 to about 8 teaspoons of abrasive particles per 100 milliliters. More preferably, the composition includes between about 0.5 to about 5 teaspoons of abrasive particles per 100 milliliters of solvent. Even more preferred, the composition includes about 0.5 to about 2 teaspoons of abrasive particles per 100 milliliters of solution.

In certain preferred embodiments, the composition includes abrasive silica particles dispersed in a solution, with any of the aforementioned solutions being used. In certain other preferred embodiments, the composition includes silica particles dispersed in a vinegar solution. Preferably, the composition includes between about 1 to 2 teaspoons of silica gel per 100 milliliters of vinegar. In other preferred embodiments, the composition includes silica particles dispersed in isopropyl alcohol and water. Preferably, the composition includes about 10 teaspoons of silica gel per 100 milliliters of isopropyl alcohol and 100 milliliters of water. In yet other certain preferred embodiments, the composition includes silica particles dispersed in a commercially available glass cleaner, e.g., Windex® brand cleaner.

With the description of the various components of a composition according to the invention having been described hereinabove, various embodiments of a composition according to the invention as described herein below can be understood.

In an embodiment of a composition according to the invention, a composition for restoring functional properties to a surface-bearing a function coating is provided. The composition comprises of abrasive particles dispersed in a solution or gel. Both the functional coating and the abrasive particles each have a hardness as measured on the Mohs scale. In this embodiment, there is a difference between the hardness of the particles and the coatings. That hardness being not greater than two on the Mohs scale.

In another embodiment of a composition according to the invention a composition for forming a functional coating on a surface is provided. The composition of this embodiment comprises abrasive particles dispersed in a solution or gel. Both the surface and the abrasive particles each have a hardness as measured on the Mohs scale. In this embodiment there is a difference between the hardness of the coating and of the particles, that difference being not greater than two on the Mohs scale.

In other embodiments, an article or a kit is provided for treating a substrate surface, either uncoated or bearing a coating. The kit generally includes a composition according to the invention and a fabric, a cloth, paper towel, sponge, kimwipe, towelette, or similar article, referred to generally or collectively as a “fabric.”. In certain embodiments, the composition and fabric are provided separately. If the composition is comprised of abrasive particles dispersed in a gel, it may be provided in a tube with a removable cap or other means for dispensing the gel. If the composition is abrasive particles dispersed in a solution, the composition may be provided in a spray bottle or like container. The kit thus may include a fabric and a tube or container. Or it may include a tube or packet of abrasive particles, a spray bottle or other container (provided with or without a solution). In this latter example, the user of the kit would dispense the abrasive particles from the tube or packet into the container, and add a liquid as necessary according to instruction included in the kit. When it is desired to treat the substrate surface, the composition is sprayed or otherwise deposited or applied on the fabric or directly on the substrate surface. The fabric is then used to treat the surface. In other embodiments, the composition and fabric are provided packaged together. Preferably, the composition and fabric are packaged together in a manner similar to packaging moist towelettes or otherwise sealed in a generally leak proof packaging. In this formulation of a kit, the fabric immersed or impregnated with the composition of the invention and prepackaged When it is desired to treat the substrate surface, the moist fabric is removed from the package and applied to the substrate surface. Fabrics suitable for use with the invention include but are not limited to sponges, paper towels, towelettes, and Kimwipes.

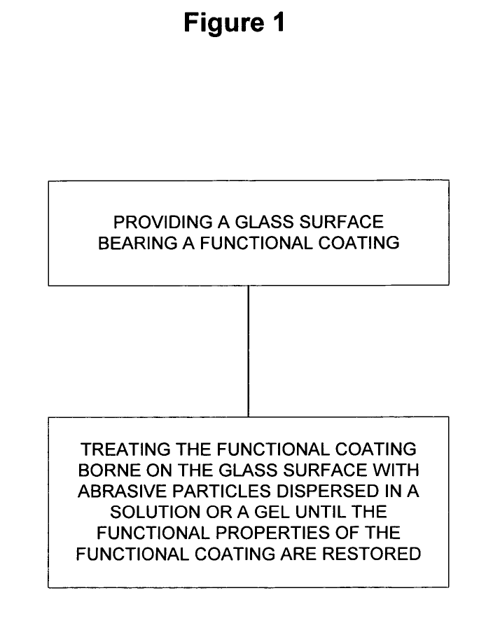

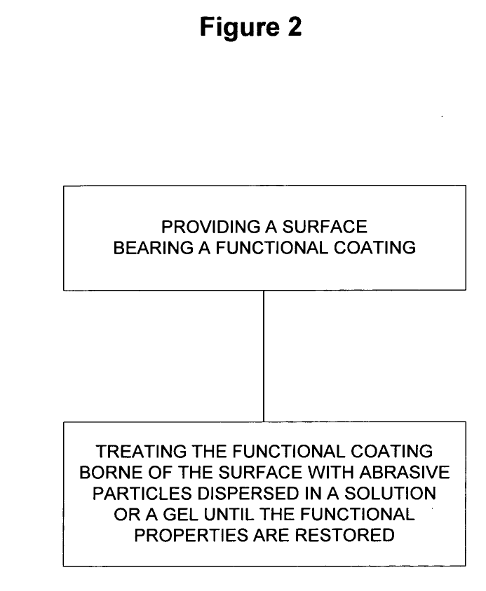

With compositions according to the invention whether in a kit or otherwise provided the methods of the invention in its various embodiments can be understood with reference to FIGS. 1 to 6. The below-described specific embodiments of the methods of the invention are carried out with use of rubbing or frictional force applied as earlier described herein above. Turning to FIG. 1 and embodiment of the invention provides a method for restoring functional properties to a glass surface bearing a functional coating. In this embodiment a glass surface bearing a functional coating, such as those previously described hereinabove is provided. The surface is treated with a composition according to the invention, abrasive particles disbursed in a solution or gel, until the functional properties of the functional coating are restored. The methods of the invention can be used to restore functional properties to a coating born on other than a glass surface; thus in another embodiment a method of restoring functional properties to a surface bearing a functional coating is provided. Turning to FIG. 2, the method of this embodiment comprises providing a surface bearing a functional coating and treating the functional coating born on the surface with a composition according to the invention, abrasive particles disbursed in a solution or gel, until the functional properties are restored.

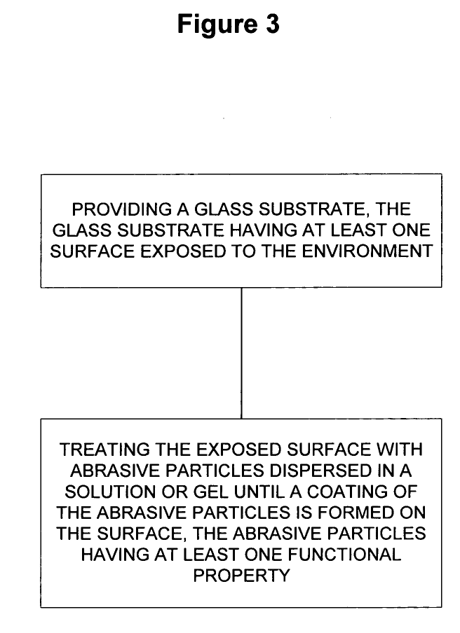

The methods of the invention can be used in part at least one functional property. Thus with reference to FIG. 3 in another embodiment of a method of the invention, a method of imparting at least one functional property to a glass substrate is provided. The method of this embodiment comprises providing a glass substrate which has at least one surface exposed to the environment. The exposed surface is treated with abrasive particles disbursed in a solution or a gel until a coating of the abrasive particles is formed on the surface. The abrasive particles have at least one functional property. The resulting coating will exhibit the functional property or properties of the abrasive particles used in the treating step.

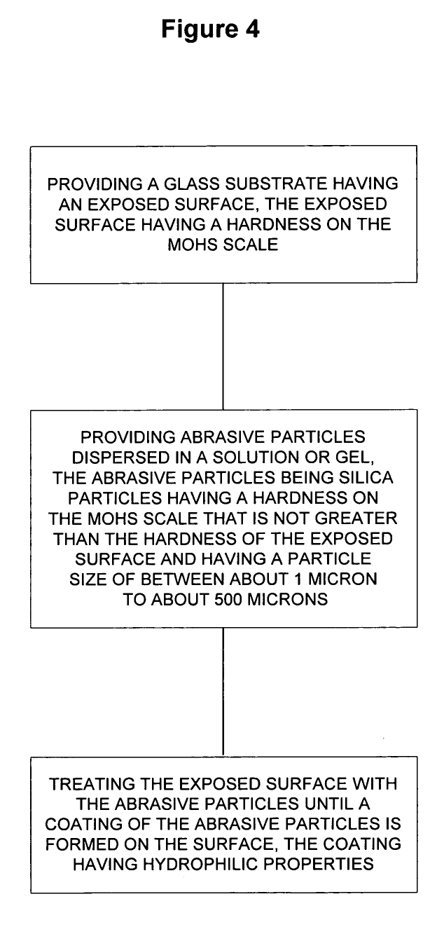

Turning to FIG. 4, a method of imparting hydrophilic functional properties to a glass substrate having an exposed surface is depicted. The method of this embodiment comprises providing a glass substrate having an exposed surface. This exposed surface has a hardness on the Mohs scale. A composition according to the invention or abrasive particles disposed in a solution or gel is provided. The abrasive particles are silica particles which have hydrophilic properties. The silica particles also have a hardness on the Mohs scale that is not greater than the hardness of the exposed surface. The particles are a size ranging between about 1 micron to about 500 microns. The exposed surface is treated with the abrasive particles until a coating of the particles is formed on the surface. The resulting coating has hydrophilic properties.

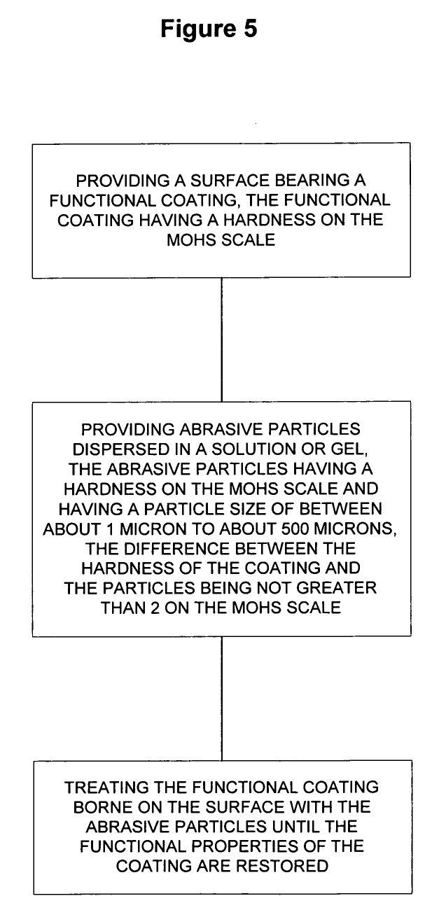

With reference to FIG. 5, another method for restoring functional properties to a surface bearing a functional coating is provided. In the method of this embodiment a surface bearing a functional coating is provided. The functional coating has a hardness on the Mohs scale. A composition or abrasive particles disbursed in a solution or gel according to the invention is provided. The abrasive particles have a hardness on the Mohs scale and have a particle size of between about 1 micron to about 500 microns. To avoid marring or scratching of the surface, the particles used in this embodiment are selected so that any difference between the hardness of the coating and the particles are not greater than 2 on the MOHS scale. The functional coating born on the surface is treating with the abrasive particles until the functional properties of the coating are restored.

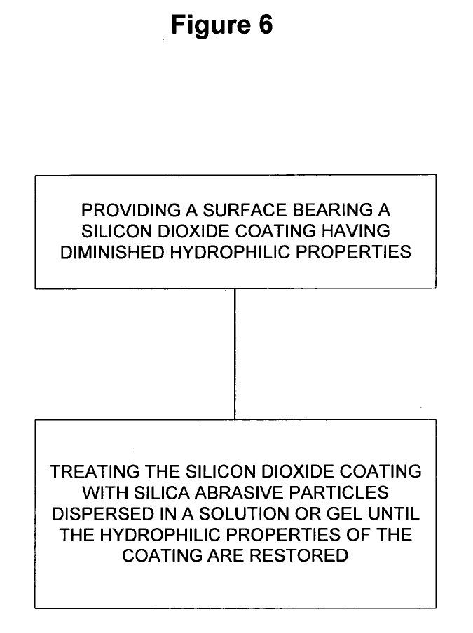

With reference to FIG. 6, another embodiment of a method according to the invention is depicted. This method is for restoring hydrophilic properties to a surface bearing a silicon dioxide coating having hydrophilic properties. In this embodiment a surface bearing a silicon dioxide coating have diminished hydrophilic properties is provided. The silicon dioxide coating is treated with abrasive silica particles disbursed in a solution or gel until the hydrophilic properties of the coating are restored.

In certain embodiments of methods according to the invention, the composition is applied to the surface without rinsing. For some embodiments, particularly some embodiments where the composition is applied to the surface as a gel, some rinsing may be desirable or required to remove visible residue.

Methods according to the invention may be further understood with reference to the following non-limiting examples which are provided for illustrative purposes.

### EXAMPLE 1

Glass sheets containing Low \overline{E}2 Plus coatings were provided. Low \overline{E}2 Plus coatings contained approximately 40 angstroms of silicon dioxide coating with a protective zinc oxide overcoat. The protective zinc oxide overcoat was removed with a vinegar solution to expose the silicon dioxide coating and activate the hydrophilic properties. The sheets were contaminated with silicone by exposing the sheets to fresh silicone in a container for a minimum of 24 hours and the areas of the sheets thus exposed exhibited hydrophobic properties. Table 1 illustrates the treatment according to methods of the invention that successfully revived or restored the hydrophilicity of the silicone-contaminated surfaces. The treatments were carried out with application of a manual rubbing or frictional force.

TABLE 1

| Composition | Treatment | Result |
|---|---|---|
| 1 tsp silica/no solution | Silica applied to unfolded towelette | Revived hydrophilic |
| | | properties |
| 1 tsp silica/100 ml vinegar | 1 oz solution applied to dry folded | Revived hydrophilic |
| solution | towelette | properties |
| 2 tsp silica/100 ml vinegar | ½ oz solution applied to dry folded | Revived hydrophilic |
| solution | towelette | properties |
| 2 tsp silica/100 ml vinegar | 1 oz solution applied to dry unfolded | Revived hydrophilic |
| solution | towelette | properties |
| 1½ tsp silica/100 ml distilled | Sprayed onto surface and wiped with | Revived hydrophilic |
| water | kimwipe | properties |
| 2 tsp silica/100 ml distilled | Sprayed onto surface and wiped with | Revived hydrophilic |
| water | kimwipe | properties |

### EXAMPLE 2

A glass sheet containing an activated Low \overline{E}2 Plus coating was exposed to intense ultraviolet radiation at 180° F. in a Canadian Fox Box for three days to deteriorate the hydrophilic properties. The glass sheets were observed to exhibit hydrophobic properties. The coated surface was washed with silica applied to an unfolded vinegar towelette. This treatment was observed to restore hydrophilic properties to the coated surface.

### EXAMPLE 3

An IG unit containing a glass sheet containing activated Low \overline{E}2 Plus coating was exposed to a glass manufacturing environment for one month. The bottom 3 inches of the sheet was exposed to silicone bleeding, resulting in a hydrophobic area. The hydrophobic area was washed with silica applied to an unfolded vinegar towelette. This treatment was observed to restore hydrophilic properties to the coated surface.

### EXAMPLE 4

An IG unit containing an uncoated glass surface was exposed to an outdoor environment for one month and became extremely hydrophobic. The hydrophobic area was washed with silica applied to an unfolded vinegar towelette. This treatment was observed to cause the uncoated glass surface becoming hydrophilic. Thus, treatment according to the invention is capable of imparting hydrophilic properties to an uncoated substrate.

While exemplary embodiments of this invention and methods of practicing the same have been illustrated and described, it should be understood that various changes, adaptations, and modifications may be made therein without departing from the spirit of the invention and the scope of the appended claims.

What is claimed:

1. A method of restoring functional properties to a glass surface bearing a functional coating, comprising:
providing a glass surface bearing a functional coating; and
treating the functional coating borne on the glass surface with abrasive particles dispersed in a solution or a gel until the functional properties of the functional coating are restored.

2. The method of claim 1, wherein the functional coating and the abrasive particles each have a hardness on the Mohs scale, the difference between the hardness of the coating and the particles being not greater than 2 on the Mohs scale.

3. The method of claims 1, wherein the function coating and the abrasive particles each have a hardness of between about 3 to about 8 on the Mohs scale and the hardness of the abrasive particles is not greater than the hardness of the functional coating.

4. The method of claim 1, wherein the functional coating and the abrasive particles each have a hardness and the hardness of the abrasive particles is not greater than the hardness of the functional coating.

5. The method of claim 1, wherein the functional coating and the abrasive particles each have a hardness and the hardness of the abrasive particles is such that the particles do not visibly mar the function coating being treated.

6. The method of claim 1, wherein the function coating has hydrophilic, hydrophobic or photocatalytic properties and the abrasive particles are comprised of a material having hydrophilic, hydrophobic or photocatalytic properties.

7. The method of claim 1, wherein the functional coating and the abrasive particles are each comprised of one or more materials selected from the group consisting of a metal oxide, a metal nitride, a metal oxynitride, a metal oxide compound, a metal nitride compound, or a metal oxynitride compound or a combination thereof.

8. The method of claim 1, wherein the functional coating is comprised of one or more layers and has an outermost layer exposed to the environment, the outermost layer comprising a metal oxide, a metal nitride or a metal oxynitride, a metal oxide compound, a metal nitride compound, a metal oxynitride compound or a combination thereof.

9. The method of claim 1, wherein the functional coating is comprised of one or more layers and has an outermost layer exposed to the environment, the outermost layer comprising silicon dioxide or titanium nitride.

10. The method of claims 1, wherein the glass surface is an exposed surface of a glass window pane, an insulating glass unit, a glass mirror or glass lenses.

11. The method of claim 1, wherein the abrasive particles have an average particle size ranging from about 1 micron to about 500 microns.

11. The method of claim 1, wherein the abrasive particles have an average particle size ranging from about 10 micron to about 300 microns.

12. The method of claim 1, wherein the abrasive particles have an average particle size ranging from about 20 micron to about 200 microns.

13. The method of claim 1, wherein the treating comprising washing the surface with abrasive particle dispersed in a solution or a gel, the abrasive particles being selected from the group consisting of silicon dioxide, titanium dioxide, zinc oxide, aluminum oxide, topaz, silicon carbide, titanium nitride, boron nitride or combinations thereof.

14. The method of claim 1, wherein the abrasive particles comprise particles selected from two or more of silicon dioxide, titanium dioxide, zinc oxide, aluminum oxide, topaz, silicon carbide, titanium nitride, boron nitride or combinations thereof.

15. The method of claim 1, wherein the particles comprise silica particles.

16. The method of claim 1, wherein the particles comprise silica gel.

17. The method of claim 1, wherein the particles comprise titanium oxide particles.

18. The method of claim 1, wherein the treating comprises washing the surface with abrasive particles dispersed in a solution, the solution comprising water, alcohol, a mildly acidic solution, a mildly basic solution, a vinegar solution, or a liquid glass cleanser.

19. The method of claim 1, wherein the treating further comprises depositing the abrasive particles dispersed in a solution onto a fabric and wiping the abrasive particles over the functional coating borne on the surface with the fabric.

20. The method of claim 1, wherein the treating further comprises depositing the abrasive particles dispersed in a solution or a gel, directly onto the surface and wiping the abrasive particles over the functional coating borne on the surface with a fabric.

21. The method of claim 1, wherein the treating further comprises providing a prepackaged fabric submersed in or impregnated with a solution having abrasive particles dispersed therein and wiping the abrasive particles over the functional coating with the fabric.

22. A method of restoring functional properties to a surface bearing a functional coating, comprising:
providing a surface bearing a functional coating; and
treating the functional coating borne on the surface with abrasive particles dispersed in a solution or a gel until the functional properties are restored.

23. The method of claim 22, wherein the functional coating and the abrasive particles each have a hardness on the Mohs scale, the difference between the hardness of the coating and the particles being not greater than 2 on the Mohs scale.

24. The method of claims 22, wherein the function coating and the abrasive particles each have a hardness of between about 3 to about 8 on the Mohs scale and the hardness of the abrasive particles is not greater than the hardness of the functional coating.

25. The method of claim 22, wherein the functional coating and the abrasive particles each have a hardness and the hardness of the abrasive particles is not greater than the hardness of the functional coating.

26. The method of claim 22, wherein the functional coating and the abrasive particles each have a hardness and the hardness of the abrasive particles is such that the particles do not visibly mar the function coating being treated.

27. The method of claim 22, wherein the function coating has hydrophilic, hydrophobic or photocatalytic properties and the abrasive particles are comprised of a material having hydrophilic, hydrophobic or photocatalytic properties.

28. The method of claim 22, wherein the functional coating and the abrasive particles are each comprised of one or more materials selected from the group consisting of a metal oxide, a metal nitride, a metal oxynitride, a metal oxide compound, a metal nitride compound, or a metal oxynitride compound or a combination thereof.

29. The method of claim 22, wherein the functional coating is comprised of one or more layers and has an outermost layer exposed to the environment, the outermost layer comprising a metal oxide, a metal nitride or a metal oxynitride, a metal oxide compound, a metal nitride compound, a metal oxynitride compound or a combination thereof.

30. The method of claim 22, wherein the functional coating is comprised of one or more layers and has an outermost layer exposed to the environment, the outermost layer comprising silicon dioxide or titanium nitride.

31. The method of claim 22, wherein the abrasive particles have an average particle size ranging from about 1 micron to about 500 microns.

32. The method of claim 22, wherein the abrasive particles have an average particle size ranging from about 10 micron to about 300 microns.

33. The method of claim 22, wherein the abrasive particles have an average particle size ranging from about 20 micron to about 200 microns.

34. The method of claim 22, wherein the treating comprising washing the surface with abrasive particle dispersed in a solution or a gel, the abrasive particles being selected from the group consisting of silicon dioxide, titanium dioxide, zinc oxide, aluminum oxide, topaz, silicon carbide, titanium nitride, boron nitride or combinations thereof.

35. The method of claim 22, wherein the abrasive particles comprise particles selected from two or more of silicon dioxide, titanium dioxide, zinc oxide, aluminum oxide, topaz, silicon carbide, titanium nitride, boron nitride or combinations thereof.

36. The method of claim 22, wherein the particles comprise silica particles.

37. The method of claim 22, wherein the particles comprise silica gel.

38. The method of claim 22, wherein the particles comprise titanium oxide particles.

39. The method of claim 22, wherein the treating comprises washing the surface with abrasive particles dispersed in a solution, the solution comprising water, alcohol, a mildly acidic solution, a mildly basic solution, a vinegar solution, or a liquid glass cleanser.

40. The method of claim 22, wherein the treating further comprises depositing the abrasive particles dispersed in a solution onto a fabric and wiping the abrasive particles over the functional coating borne on the surface with the fabric.

41. The method of claim 22, wherein the treating further comprises depositing the abrasive particles dispersed in a solution or a gel, directly onto the surface and wiping the abrasive particles over the functional coating borne on the surface with a fabric.

42. The method of claim 22, wherein the treating further comprises providing a prepackaged fabric submersed in or impregnated with a solution having abrasive particles dispersed therein and wiping the abrasive particles over the functional coating with the fabric.

43. A method of imparting at least one functional property to a glass substrate, comprising:
providing a glass substrate, the glass substrate having at least one surface exposed to the environment;
treating the exposed surface with abrasive particles dispersed in a solution or a gel until a coating of the abrasive particles is formed on the surface, the abrasive particles having at least one functional property.

44. A method of imparting hydrophilic functional properties to a glass substrate having an exposed surface, comprising;
providing a glass substrate having an exposed surface, the exposed surface having a hardness on the Mohs scale,
providing abrasive particles dispersed in a solution or gel, the abrasive particles being silica particles having a hardness on the Mohs scale that is not greater than the hardness of the exposed surface and having a particle size of between about 1 micron to about 500 microns; and
treating the exposed surface with the abrasive particles until a coating of the abrasive particles is formed on the surface, the coating having hydrophilic properties.

45. The method of claim 43 or claim 44, wherein the abrasive particles are dispersed in a solution and the treating further comprises depositing the abrasive particles dispersed in a solution onto a fabric and wiping the abrasive particles over the surface with the fabric.

46. The method of claim 43 or claim 44, wherein the treating further comprises depositing the abrasive particles dispersed in a solution or a gel directly onto the surface and wiping the abrasive particles over the surface with a fabric.

47. The method of claim 43 or 44, wherein the treating further comprises providing a prepackaged fabric submersed in or impregnated with a solution having abrasive particles dispersed therein and wiping the abrasive particles over the surface with the fabric.

48. A method of restoring functional properties to a surface bearing a functional coating, comprising;
providing a surface bearing a functional coating, the functional coating having a hardness on the Mohs scale,
providing abrasive particles dispersed in a solution or gel, the abrasive particles having a hardness on the Mohs scale and having a particle size of between about 1 micron to about 500 microns, the difference between the hardness of the coating and the particles being not greater than 2 on the Mohs scale;
treating the functional coating borne on the surface with the abrasive particles until the functional properties of the coating are restored.

49. A method of restoring hydrophilic properties to a surface bearing a silicon dioxide coating having hydrophilic properties, comprising:
providing the surface bearing a silicon dioxide coating having hydrophilic properties; and
treating the silicon dioxide coating with silica abrasive particles dispersed in a solution or a gel until the hydrophilic properties of the coating are restored.

50. A composition for restoring functional properties to a surface bearing a functional coating, comprising abrasive particles dispersed in a solution or a gel, wherein the functional coating and the abrasive particles each have a hardness as measured on the Mohs scale and the difference between the hardness of the coating and the particles being not greater than 2 on the Mohs scale.

51. A composition for forming a functional coating on a surface, comprising abrasive particles dispersed in a solution or gel, wherein the surface and the abrasive particles each have a hardness as measured on the Mohs scale and the difference between the hardness of the coating and the particles being not greater than 2 on the Mohs scale.

52. The composition of claim 50, wherein the functional coating and the abrasive particles each have a hardness of between about 3 to about 8 on the Mohs scale.

53. The composition of claim 51, wherein the surface and the abrasive particles each have a hardness of between about 3 to about 8 on the Mohs scale.

54. The compositions of claim 50, wherein the functional coating and the abrasive particles each have a hardness and the hardness of the abrasive particles is such that the particles do not visibly mar the functional coating when treated with the particles.

55. The compositions of claim 51, wherein the surface and the abrasive particles each have a hardness and the hardness of the abrasive particles is such that the particles do not visibly mar the surface when treated with the particles.

56. The composition of claim 50 or claim 51, wherein the abrasive particles have an average particle size ranging from about 1 micron to about 500 microns.

57. The composition of claim 50 or claim 51, wherein the abrasive particles have an average particle size ranging from about 10 micron to about 300 microns.

58. The composition of claim 50 or claim 51, wherein the abrasive particles have an average particle size ranging from about 20 micron to about 200 microns.

59. The composition of claim 50 or claim 51, wherein the abrasive particles comprise one or more materials selected from the group consisting of a metal oxide, a metal nitride, a metal oxynitride, a metal oxide compound, a metal nitride compound, or a metal oxynitride compound or a combination thereof.

60. The composition of claim 50 or claim 51, wherein the abrasive particles comprise particles selected from one or more of silicon dioxide, titanium dioxide, zinc oxide, aluminum oxide, topaz, silicon carbide, titanium nitride, and boron nitride.

61. The composition of claim 50 or claim 51, wherein the abrasive particles comprise particles formed of a ceramic material or a dielectric material.

62. The composition of claim 50 or 51, wherein the abrasive particles comprise silica particles dispersed in a solution.

63. The composition of claim 50 or 51, wherein the abrasive particles comprise silica particles dispersed in a gel.

64. The composition of claim 50 or 51, wherein the abrasive particles comprise titanium oxide particles dispersed in a solution or a gel.

65. The composition of claim 50 or 51, wherein the abrasive particles are dispersed in a solution, the solution comprising water, alcohol, a mildly acidic solution, a mildly basic solution, a vinegar solution, or a liquid glass cleanser.

66. The composition of claim 50, wherein the abrasive particles are dispersed in a solution, the solution being a liquid that disperses the particles and reduces friction between the particles, the functional coating and a fabric or other material used to apply manual or mechanic rubbing force to the functional coating during a treating step.

67. The composition of claim 51, wherein the abrasive particles are dispersed in a solution, the solution being a liquid that disperses the particles and reduces friction between the particles, the surface and a fabric or other material used to apply manual or mechanic rubbing force to the surface during a treating step.

68. The composition of claim 50 or 51, wherein the abrasive particles are dispersed in a solution, the solution comprising water.

69. The composition of claim 50 or 51, wherein the abrasive particles are dispersed in a solution, the particles being about ½ teaspoon to about 8 teaspoons of abrasive particles per 100 milliliters of solution.

70. The composition of claim 50 or 51, wherein the abrasive particles are dispersed in a solution, the particles being about ½ teaspoon to about 5 teaspoons of abrasive particles per 100 milliliters of solution.

71. The composition of claim 50 or 51, wherein the abrasive particles are dispersed in a solution, the particles being about 0.5 teaspoon to about 2 teaspoons of abrasive particles per 100 milliliters of solution.

72. The composition of claim 50 or 51, wherein the abrasive particles are dispersed in a solution, the solution comprising a mild acid or mild base.

73. The composition of claim 50 or 51, wherein the abrasive particles are dispersed in a solution, the solution comprising vinegar.

74. The composition of claim 50 or 51, wherein the abrasive particles are dispersed in a solution, the solution comprising citric acid.

75. The composition of claim 50 or 51, wherein the abrasive particles are dispersed in a solution, the solution comprising a liquid glass cleaner.

76. The composition of claim 50 or 51, wherein the abrasive particles are dispersed in a solution, the solution comprising isopropyl alcohol and water.

77. The composition of claim 50 or 51, wherein the abrasive particles are dispersed in a solution the solution comprises about 50% isopropyl alcohol and about 50% water.

78. An article for restoring functional properties to a surface bearing a functional coating, comprising a fabric impregnated with a solution containing abrasive particles, the functional coating and the abrasive particles each have a hardness as measured on the Mohs scale and the difference between the hardness of the coating and the particles being not greater than 2 on the Mohs scale.

79. An article for forming a functional coating on a surface, comprising a fabric impregnated with a solution containing abrasive particles, the surface and the abrasive particles each have a hardness as measured on the Mohs scale and the difference between the hardness of the surface and the particles being not greater than 2 on the Mohs scale.

80. An article for cleaning a glass surface, comprising a fabric impregnated with a solution containing abrasive particles, the glass surface and the abrasive particles each have a hardness as measured on the Mohs scale and the difference between the hardness of the glass surface and the particles being not greater than 2 on the Mohs scale.

81. A kit for restoring functional properties to a surface bearing a functional coating, comprising:
a fabric for washing the surface bearing a functional coating; and
a solution containing abrasive particles, wherein the functional coating and the abrasive particles each have a hardness as measured on the Mohs scale and the difference between the hardness of the coating and the particles being not greater than 2 on the Mohs scale.

82. A kit for forming a functional coating on a surface, comprising:
a fabric for washing the surface; and
a solution containing abrasive particles, wherein the surface and the abrasive particles each have a hardness as measured on the Mohs scale and the difference between the hardness of the surface and the particles being not greater than 2 on the Mohs scale.

83. A kit for washing a glass surface, comprising:
a fabric for washing the glass surface; and
a solution containing abrasive particles, wherein the glass surface and the abrasive particles each have a hardness as measured on the Mohs scale and the difference between the hardness of the glass surface and the particles being not greater than 2 on the Mohs scale.

84. The kit of any one of claims 82-83, wherein the solution is contained in a spray bottle.

85. The kit of any one of claims 82-83, wherein the fabric is prepackaged in the solution.
